(19) United States
(12) Patent Application Publication
(10) Pub. No.: US 2026/0114380 A1
(43) Pub. Date: Apr. 30, 2026

(54) METHODS AND SYSTEMS FOR AUTOMATED FOOD GROWING

(71) Applicants: JEFF RAYMOND, Houston, TX (US); Eden Growth Systems, Inc., Houston, TX (US)

(72) Inventor: JEFF RAYMOND, Houston, TX (US)

(21) Appl. No.: 19/118,876

(22) PCT Filed: Oct. 6, 2023
(86) PCT No.: PCT/US2023/034660

§ 371 Date: Apr. 7, 2025

Related U.S. Application Data
(60) Provisional application No. 63/414,230, filed on Oct. 7, 2022.

(51) Int. Cl. A01G 7/00

(52) U.S. Cl. CPC A01G 7/00

(57) ABSTRACT

The systems and methods herein may reduce the time humans spend growing the food they need, automate the monitoring and control of food growing conditions, and/or learn from failures and successes to ensure future crop success in a variety of terrestrial and non-terrestrial environments. The systems and methods may employ one or more actuators, one or more sensors, a machine learning/artificial intelligence module, and/or a human interface device.

### CROSS-REFERENCE TO RELATED APPLICATIONS

This application claims priority from International Patent Application No. PCT/US2023/034660, filed on Oct. 6, 2023, which claims priority from U.S. Patent Application No. 63/414,230, filed on Oct. 7, 2022, the entire disclosures of which are incorporated herein by reference.

The present application is related to US Publication No. 2021/0169027 filed on Feb. 19, 2021 as Ser. No. 17/180,374 which application is incorporated herein by reference. The present application is also related to US Publication No. 2020/0100442 filed on Jun. 19, 2020 as Ser. No. 16/445,528 which application is incorporated herein by reference.

### FIELD OF THE DISCLOSURE

The present disclosure relates to methods and systems for automated food growing and in some embodiments the disclosure relates to control systems used in such methods and systems that may be called “Unmanned Food Growing Systems Control System” (UFGS-CS).

### BACKGROUND AND SUMMARY

Growing food is often a time intensive, skill intensive, repetitive, dirty, and difficult chore such that many people avoid it. What is needed are improved methods and systems for growing food that reduces human involvement, increases growing efficiency, are cost-effective, and have predictable, reliable results.

Advantageously, the systems and methods described herein accomplish one or more up to all of the aforementioned goals. That is, the Control System for Unmanned Food Growing Robots may reduce the time humans spend growing the food they need, automate the monitoring and control of food growing conditions, and/or learn from failures and successes to ensure future crop success in a variety of terrestrial and non-terrestrial environments.

In one embodiment the application pertains to a system or a method for growing food. The systems and methods may employ one or more actuators, one or more sensors, a machine learning/artificial intelligence module, and/or a human interface device. If desired, human-on-the-loop feedback may be employed. The systems and methods advantageously allow one to efficiently and cost-effectively grow plants, fish or other aquatic sealife, animals, or any other biological system with limited human intervention or involvement. The location for growing is not particularly limited and may include, for example, grow towers, indoors, outdoors, back yards, trailers, sheds, greenhouses, bodies of water, the moon, other planets, or any combination thereof. The control systems and methods may be applied to virtually any environment including, for example, conventional growth environments as well as aeroponic, aquaponic, and/or hydroponic environments.

These and other objects, features and advantages of the exemplary embodiments of the present disclosure will become apparent upon reading the following detailed description of the exemplary embodiments of the present disclosure, when taken in conjunction with the appended claims.

### BRIEF DESCRIPTION OF THE DRAWINGS

Various embodiments of the present disclosure, together with further objects and advantages, may best be understood by reference to the following description taken in conjunction with the accompanying drawings.

FIG. 1 shows an embodiment of the present systems and processes wherein a human operator interacts with a human interface device (HID) while the HID interfaces with actuators and sensors to issue commands from a human operator or an operatively connected artificial intelligence system to more efficiently grow food with minimal human involvement.

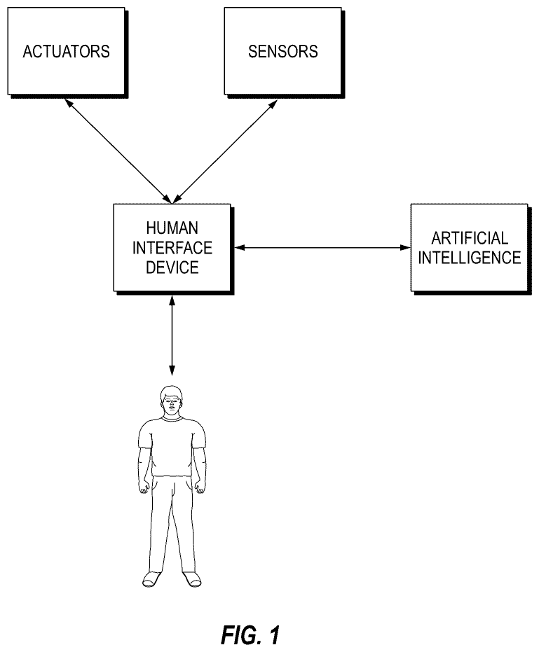

FIG. 2 shows a representative printed circuit board (PCB) that may be employed in the control systems and methods herein. The PCB may include a PIC microcontroller, relays, and/or be operably connected to a mobile device.

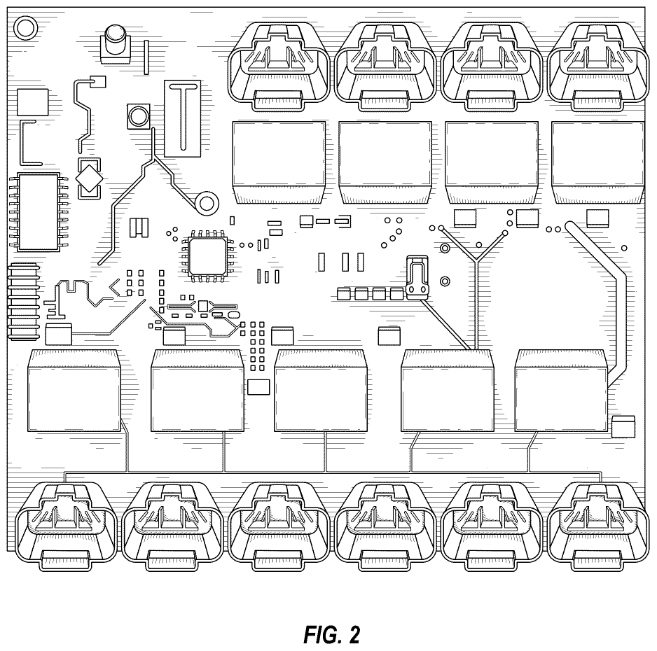

FIG. 3 shows a representative printed circuit board (PCB) that may be employed in the control systems and methods herein. The PCB may include a PIC microcontroller, relays, sensors (e.g., pH, DO, EC, temperature, humidity, etc.), power monitoring, battery back-up, and/or be operably connected to a mobile device.

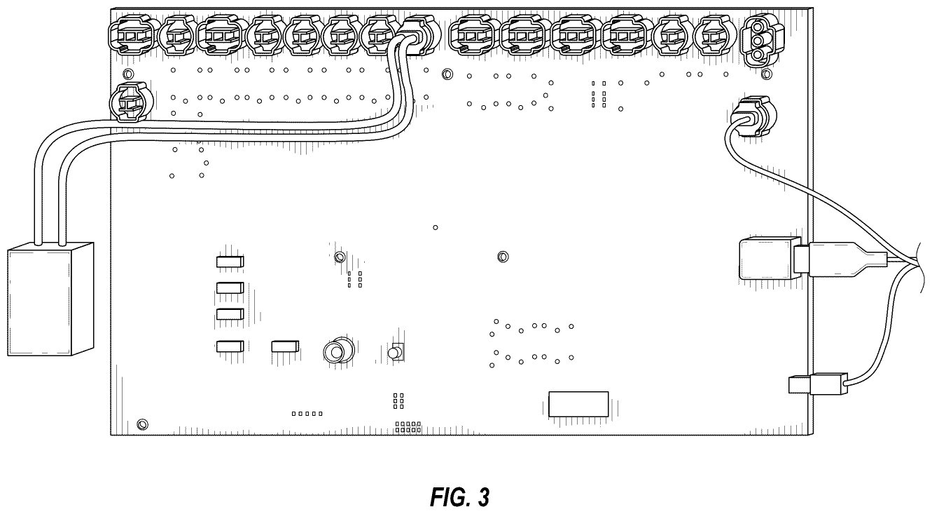

### DETAILED DESCRIPTION

The following description of embodiments provides a non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

In one embodiment, an operator may choose which crop or crops are desired to be grown and enters them into a processor such as a mobile device or a PC. A machine learning/artificial intelligence module (AI) reviews pre-collected data on the crop type, the location, atmospheric conditions, available sensors and actuators to determine and recommend growing conditions for the plant given plant maturity phase. Such recommended conditions may take into account cost/availability of resources, time to maturity, desired harvest, and other factors. The AI then informs the human as to the method to plant given stated conditions (i.e. indoor growing, outdoor growing, soil growing, hydroponics, etc) and provides help in performing the planting.

The mobile device or PC employed may include software to connect it to a cloud server, a local server, or combination thereof. In this manner one may control a number of grow locations and remotely monitor or intervene as necessary. Such monitoring or controlling may include tracking what is planted and where, tracking time to maturity, and controlling system variables such as temperature, amount of nutrients and water, etc.

Once planted the AI may utilize sensor data collected and processed by the processor to monitor plant growth. An integrated camera in the system, e.g., in the HID if present, enables the collecting of imagery (still and motion) which is further analyzed by the AI to ensure plant health and provide recommendations or automated actions for improvement of plant health. If desired, one or more cameras may be equipped with or coupled to a machine learning program or module to automate inspection, processes, or robots using algorithms and statistical models to analyze and draw inferences from patterns in the camera images. As the plant matures the AI determines suitable to optimum water, nutrient, lighting, wind speed settings (as applicable given chosen grow method i.e. indoors, outdoors) and may modify system settings and actuate needed control items to ensure optimum plant growth. The human may help provide additional feedback by rating the performance of the plants maturation/health via the HID or direct input into a processor. In this manner the systems an methods enable humans to fully oversee their own grow operations without having to dedicate a voluminous time commitment to ensure they learn all that is required to grow their own food. As the UFGC-CS is more broadly adopted it gains even more data to inform the AI of special grow conditions by crop type thus helping ensure even more successful harvest in the future

In some embodiments the system may take the form of a printed circuit board (PCB) with actuator and sensor interfaces, a mobile human interface device (HID) that can interact with the PCB, a cloud based Artificial Intelligence (AI), and the human operator.

### Specific Embodiments

1. A system for growing food comprising:
one or more actuators located on a location for growing a crop;
one or more sensors configured to transmit one or more signals pertaining to a plant condition located on the location for growing the crop;
a machine learning/artificial intelligence module operably connected to the one or more sensors to receive the one or more transmitted signals pertaining to a plant condition and wherein the machine learning/artificial intelligence module is operably connected to the one or more actuators to transmit one or more signals to the one or more actuators to take an action to facilitate plant growth; and
a human interface device operably connected to the a machine learning/artificial intelligence module and configured to provide human on the loop feedback to the machine learning/artificial intelligence module and wherein the human interface device is operably connected to the one or more actuators and configured for a human operator to transmit one or more signals to the one or more actuators.

2. The system of embodiment 1 which further comprises a camera configured to collect images about the plant condition and transmitting the images to the machine learning/artificial intelligence module.

3. The system of embodiment 2 wherein the images are still, motion, or a combination thereof.

4. The system of embodiment 1 wherein the one or more sensors configured to transmit one or more signals pertaining to a plant condition are selected from sensors configured to measure temperature, CO₂ content, O₂ content, pH, nitrogen, phosphorus, potassium, calcium, sulfur, iron, boron, chloride, sodium, or any combination thereof.

5. The system of embodiment 1 wherein the location for growing a crop comprises a grow tower.

6. The system of embodiment 5 wherein the grow tower comprises a component operably connected to the one or more actuators and wherein the component is a motor, a pump, a waste digester, a water reservoir, a water sprayer, a lighting system, a temperature control system, or any combination thereof.

7. A method for growing food comprising:
entering data on a crop to be grown into a processor operatively connected to a machine learning/artificial intelligence module;
processing the data on the crop to be grown using the processor operatively connected to the machine learning/artificial intelligence module and generating one or more recommended conditions to grow the crop;
displaying the one or more recommended conditions to grow the crop;
planting the crop at a location wherein the location comprises:
   one or more actuators;
   one or more sensors configured to transmit one or more signals pertaining to a plant condition to the machine learning/artificial intelligence module;
   using the machine learning/artificial intelligence module to process one or more actions to facilitate plant growth and transmitting one or more signals to the one or more actuators to take the action to facilitate plant growth.

8. The method of embodiment 7 which further comprises collecting images with a camera about the plant condition and transmitting the images to the machine learning/artificial intelligence module.

9. The method of embodiment 8 wherein the images are still, motion, or a combination thereof.

10. The method of embodiment 7 wherein the one or more sensors configured to transmit one or more signals pertaining to a plant condition are selected from sensors configured to measure temperature, CO₂ content, O₂ content, pH, nitrogen, phosphorus, potassium, calcium, sulfur, iron, boron, chloride, sodium, or any combination thereof.

11. The method of embodiment 7 wherein the location for growing a crop comprises a grow tower.

12. The method of embodiment 11 wherein the grow tower comprises a component operably connected to the one or more actuators and wherein the component is a motor, a pump, a waste digester, a water reservoir, a water sprayer, a lighting system, a temperature control system, or any combination thereof.

We claim:

1. A system for growing food comprising:
one or more actuators located on a location for growing a crop;
one or more sensors configured to transmit one or more signals pertaining to a plant condition located on the location for growing the crop;
a machine learning/artificial intelligence module operably connected to the one or more sensors to receive the one or more transmitted signals pertaining to a plant condition and wherein the machine learning/artificial intelligence module is operably connected to the one or more actuators to transmit one or more signals to the one or more actuators to take an action to facilitate plant growth; and
a human interface device operably connected to the a machine learning/artificial intelligence module and configured to provide human on the loop feedback to the machine learning/artificial intelligence module and wherein the human interface device is operably connected to the one or more actuators and configured for a human operator to transmit one or more signals to the one or more actuators.

2. The system of claim 1 which further comprises a camera configured to collect images about the plant condition and transmitting the images to the machine learning/artificial intelligence module.

3. The system of claim 2 wherein the images are still, motion, or a combination thereof.

4. The system of claim 1 wherein the one or more sensors configured to transmit one or more signals pertaining to a plant condition are selected from sensors configured to measure temperature, CO₂ content, O₂ content, pH, nitrogen, phosphorus, potassium, calcium, sulfur, iron, boron, chloride, sodium, or any combination thereof.

5. The system of claim 1 wherein the location for growing a crop comprises a grow tower.

6. The system of claim 5 wherein the grow tower comprises a component operably connected to the one or more actuators and wherein the component is a motor, a pump, a waste digester, a water reservoir, a water sprayer, a lighting system, a temperature control system, or any combination thereof.

7. A method for growing food comprising:
entering data on a crop to be grown into a processor operatively connected to a machine learning/artificial intelligence module;
processing the data on the crop to be grown using the processor operatively connected to the machine learning/artificial intelligence module and generating one or more recommended conditions to grow the crop;
displaying the one or more recommended conditions to grow the crop;
planting the crop at a location wherein the location comprises:
one or more actuators;
one or more sensors configured to transmit one or more signals pertaining to a plant condition to the machine learning/artificial intelligence module;
using the machine learning/artificial intelligence module to process one or more actions to facilitate plant growth and transmitting one or more signals to the one or more actuators to take the action to facilitate plant growth.

8. The method of claim 7 which further comprises collecting images with a camera about the plant condition and transmitting the images to the machine learning/artificial intelligence module.

9. The method of claim 8 wherein the images are still, motion, or a combination thereof.

10. The method of claim 7 wherein the one or more sensors configured to transmit one or more signals pertaining to a plant condition are selected from sensors configured to measure temperature, CO₂ content, O₂ content, pH, nitrogen, phosphorus, potassium, calcium, sulfur, iron, boron, chloride, sodium, or any combination thereof.

11. The method of claim 7 wherein the location for growing a crop comprises a grow tower.

12. The method of claim 11 wherein the grow tower comprises a component operably connected to the one or more actuators and wherein the component is a motor, a pump, a waste digester, a water reservoir, a water sprayer, a lighting system, a temperature control system, or any combination thereof.
